(19) United States
(12) Patent Application Publication
(10) Pub. No.: US 2026/0329039 A1
(43) Pub. Date: Oct. 22, 2026

(54) ULTRA-BEND-RESISTANT FLEXIBLE BRAIDED MULTI-CORE MPO PRE-TERMINATED ASSEMBLY

(71) Applicants: GUANGDONG HENGTONG OPTIC-ELECTRONICAL TECHNOLOGY CO,LTD, Dongguan (CN); Jiangsu Hengtong Optoelectronics Co., Ltd., Suzhou (CN)

(72) Inventors: Tiantian Wu, Huaihua (CN); Weifeng Lin, Suzhou (CN); Hailin Zhang, Shenzhen (CN); Wenchao Dou, Suzhou (CN); Tengfei Wei, Xi'an (CN); Qiang Liu, Chengdu (CN); Chenyan Wang, Dongguan (CN); Aosheng Wu, Xinyang (CN); Jianchun Li, Dangyang (CN); Hongkai Jiang, Luoyang (CN); Cuiping Zhang, Chenzhou (CN)

(21) Appl. No.: 19/642,402

(22) Filed: Apr. 8, 2026

(30) Foreign Application Priority Data
Mar. 12, 2026 (CN) 202610301486.5

(51) Int. Cl. G02B 6/44

(52) U.S. Cl. CPC G02B 6/4432

(57) ABSTRACT

An ultra-bend-resistant flexible braided multi-core MPO pre-terminated assembly, comprising a multi-core ultra-bend-resistant flexible braided optical cable. Both ends of the optical cable are provided with an external black heat-shrinkable tube for a branch device. Multi-core ultra-bend-resistant flexible braided empty tubes are symmetrically arranged at each branch device, and each empty tube is sequentially connected to a connector rubber protective boot, a multi-core connector, a tip, and a tip protective cap. By adding an outer braided layer to a conventional optical cable, the present invention protects the outer jacket of the multi-core optical cable and improves its minimum bending radius, long-term and short-term crush resistance, kink resistance, and 180-degree bending resistance, ensuring that the cable jacket does not crack and that no fiber damage or breakage occurs.

### CROSS-REFERENCE TO RELATED APPLICATIONS

This application claims priority to Chinese Patent Application No. 202610301486.5, filed on Mar. 12, 2026, which is hereby incorporated by reference in its entirety.

### TECHNICAL FIELD

The present disclosure relates to the field of optical fiber technology, and in particular, to an ultra-bend-resistant flexible braided multi-core MPO pre-terminated assembly.

### BACKGROUND

As Internet data centers evolve toward ultra-large scale and ultra-high density, network architectures impose increasingly stringent requirements on transmission bandwidth and on-site cabling. In the context of current technological evolution, the ultra-bend-resistant flexible braided multi-core MPO pre-terminated product based on parallel optical transmission technology is expected to become the preferred solution for network construction from 100G to 800G, and even for future 1.6T networks.

When a multi-core MPO pre-terminated assembly is routed through pipe bends or confined spaces, workers often force it through in a manner that violates the minimum bending radius. Pulling directly from the end connector concentrates all tensile force at the junction between the connector and the optical fiber, which can easily result in the internal optical fiber being pulled out from the termination point or broken. When multiple cables are laid in parallel, the duct becomes congested, leading to increased friction. Moreover, the duct may contain burrs or sharp edges, which can scratch the outer jacket of the MPO pre-terminated assembly during passage while subjecting it to significant lateral compression and bending forces. In addition, construction personnel may lack awareness of the fragility of high-density optical fiber products and may continue to use rough installation practices originally developed for traditional copper cables or single-core optical fibers.

### SUMMARY

In view of the deficiencies of the prior art, the present invention provides an ultra-bend-resistant flexible braided multi-core MPO pre-terminated assembly, which addresses the problems set forth in the above background section.

To achieve the above objective, the present invention adopts the following technical solution:

An ultra-bend-resistant flexible braided multi-core MPO pre-terminated assembly comprises a multi-core ultra-bend-resistant flexible braided optical cable. Both ends of the multi-core ultra-bend-resistant flexible braided optical cable are provided with an external black heat-shrinkable tube for a branch device. A side of the external black heat-shrinkable tube for the branch device away from the multi-core ultra-bend-resistant flexible braided optical cable is provided with mutually symmetrical multi-core ultra-bend-resistant flexible braided empty tubes. A side of each of the multi-core ultra-bend-resistant flexible braided empty tubes away from the external black heat-shrinkable tube for the branch device is provided with a connector rubber protective boot. An end of each of the connector rubber protective boots away from the multi-core ultra-bend-resistant flexible braided empty tube is provided with a multi-core connector. An end of each of the multi-core connectors away from the connector rubber protective boot is provided with a tip, and an outer wall of the tip is provided with a tip protective cap.

Preferably, the ultra-bend-resistant flexible braided multi-core MPO pre-terminated optical cable system comprises a multi-core ultra-bend-resistant flexible braided optical cable and, sequentially arranged at both ends thereof, an external black heat-shrinkable tube for a branch device, a multi-core ultra-bend-resistant flexible braided empty tube, a connector rubber protective boot, a multi-core connector, a tip, and a tip protective cap. The components work in coordination to ensure stable operation and efficient data transmission of the optical cable in complex environments.Optionally, the lower layer is a waterproof layer with water-resistant properties.

Further, the number of the external black heat-shrinkable tubes for a branch device is two, the number of the multi-core ultra-bend-resistant flexible braided empty tubes is four, the number of the connector rubber protective boots is four, the number of the multi-core connectors is four, the number of the tip protective caps is four, and the number of the tips is four.

Preferably, in the ultra-bend-resistant flexible braided multi-core MPO pre-terminated optical cable, there are two external black heat-shrinkable tubes for a branch device, respectively located at two ends of the optical cable, and the numbers of the multi-core ultra-bend-resistant flexible braided empty tubes, the connector rubber protective boots, the multi-core connectors, the tip protective caps, and the tips are each four. The quantity configuration of the components is reasonable, and the components work in coordination to ensure stable operation and efficient data transmission of the optical cable system.

Further, the multi-core ultra-bend-resistant flexible braided optical cable comprises a braided layer, an outer jacket is provided between opposite inner walls of the braided layer, an aramid yarn layer is provided between opposite inner walls of the outer jacket, and a plurality of optical fibers are provided inside the aramid yarn layer.

Preferably, the multi-core ultra-bend-resistant flexible braided optical cable consists of, in sequence, a braided layer, an outer jacket, an aramid yarn layer, and a plurality of optical fibers. The braided layer provides flexibility and mechanical resistance, the outer jacket enhances mechanical strength and protects against external intrusion, the aramid yarn layer improves tensile strength, and the optical fibers are responsible for high-speed data transmission. The layers work in coordination to ensure the performance of the optical cable.

Further, the braided layer is made of MPO braided cable material, specifically PET material.

Preferably, the braided layer of the multi-core ultra-bend-resistant flexible braided optical cable is made of PET material, which serves as an MPO braided cable material. The material offers advantages such as high strength and toughness, good chemical resistance, excellent weatherability, and ease of processing and molding. It provides reliable protection for the internal components of the optical cable, adapts to various harsh environments, reduces electromagnetic interference, and ensures stable operation and high-quality signal transmission of the optical cable.

Further, the outer jacket is made of nylon material.

Preferably, the outer jacket of the multi-core ultra-bend-resistant flexible braided optical cable is made of nylon material. The material offers advantages such as high strength and hardness, good flexibility, excellent wear resistance, chemical resistance, and a certain degree of flame retardancy. These characteristics enable the outer jacket to effectively protect the internal components of the optical cable, adapt to complex installation environments and harsh service conditions, extend the service life of the optical cable, enhance operational safety, and ensure stable and reliable operation of the optical cable.

Further, the aramid yarn layer is made of PTFE material.

Preferably, the aramid yarn layer of the multi-core ultra-bend-resistant flexible braided optical cable is made of PTFE material. The material features excellent chemical stability, an extremely low coefficient of friction, wide temperature applicability, good electrical insulation, and hydrophobicity. These characteristics enable the aramid yarn layer to effectively protect the internal optical fibers, adapt to complex and harsh environments, reduce energy loss and wear, ensure stable signal transmission, enhance the safety and service life of the optical cable, and provide a solid guarantee for reliable operation of the optical cable.

Compared with the prior art, the present invention has the following advantages:
1:Improving the bending resistance of the multi-core MPO pre-terminated assembly. By applying an outer braided layer to a conventional optical cable, the outer jacket of the multi-core optical cable is protected, and the minimum bending radius of the optical cable is improved. The performance in terms of long-term and short-term crush resistance, kink resistance, and 180-degree bending resistance ensures that the optical cable jacket does not crack, and that no fiber damage or breakage occurs. By providing an outer braided layer for conventional multi-core MPO pre-terminated products, the bending resistance of the multi-core MPO pre-terminated assembly is enhanced, ensuring product reliability even under a 180-degree bending condition.
2.Achieving ultra-high tensile strength of the connector. By designing a crimping slider and a crimping process adapted to the ultra-bend-resistant flexible braided multi-core MPO pre-terminated product, as well as a dedicated stripping process and stripping tool, the tensile strength of the connector of the ultra-bend-resistant flexible braided multi-core MPO pre-terminated product reaches 100 N, which is far higher than the industry standard of 60 N. This ensures product quality even under rough installation practices or improper pulling. The ultra-bend-resistant flexible braided multi-core MPO pre-terminated assembly achieves ultra-high tensile strength of the connector, with a tensile strength reaching 100 N, far exceeding the industry standard.

### BRIEF DESCRIPTION OF THE DRAWINGS

It should be noted that better understanding of various aspects of the present disclosure may be achieved after reading the following detailed embodiments with reference to the accompanying drawings, and positions, dimensions, and scales of structures shown in the drawings do not necessarily reflect actual positions, dimensions, and scales. Reference numerals in the figures:

FIG. 1 is a schematic structural diagram of the overall assembly according to the present invention.

FIG. 2 is a schematic structural diagram with the tip protective cap removed according to the present invention.

FIG. 3 is a schematic structural diagram of the multi-core connector according to the present invention.

FIG. 4 is an enlarged schematic structural diagram of portion A of FIG. 3 according to the present invention.

FIG. 5 is a schematic cross-sectional structural diagram of the multi-core ultra-bend-resistant flexible braided optical cable according to the present invention.

FIG. 6 is a schematic diagram showing the multi-core structure of the multi-core ultra-bend-resistant flexible braided optical cable according to the present invention.

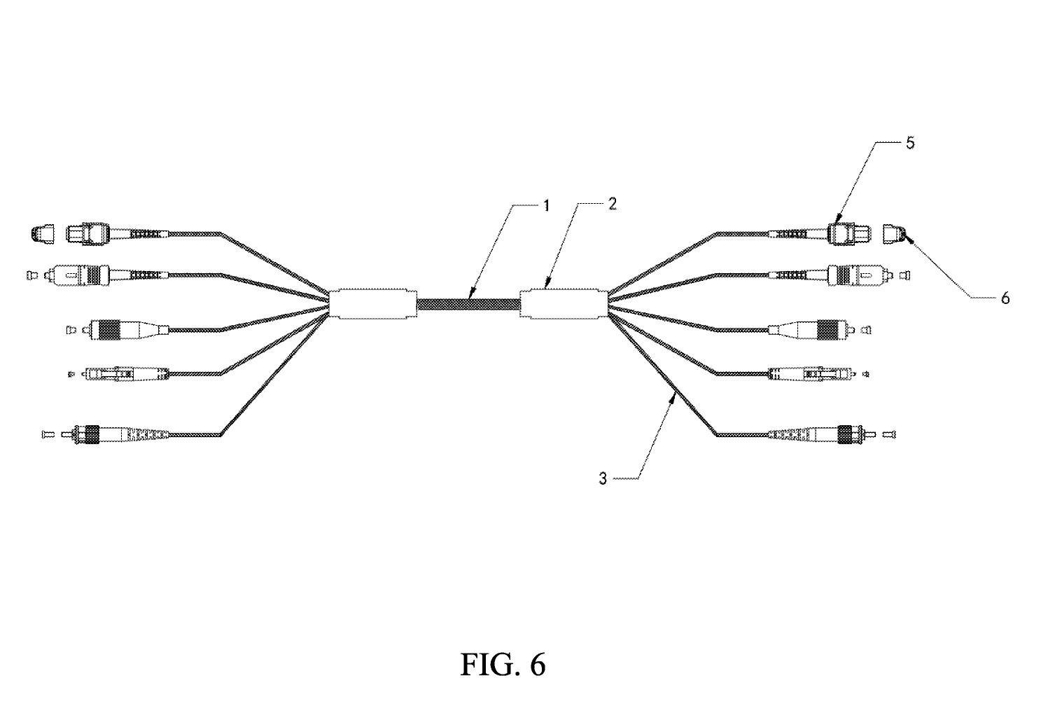

In the drawings: 1 — multi-core ultra-bend-resistant flexible braided optical cable;101 — braided layer;102 — outer jacket;103 — aramid yarn layer;104 — optical fiber;2 — external black heat-shrinkable tube for branch device;3 — multi-core ultra-bend-resistant flexible braided empty tube;4 — connector rubber protective boot;5 — multi-core connector;6 — tip protective cap;7 — tip.

### DESCRIPTION OF EMBODIMENTS

### Example 1

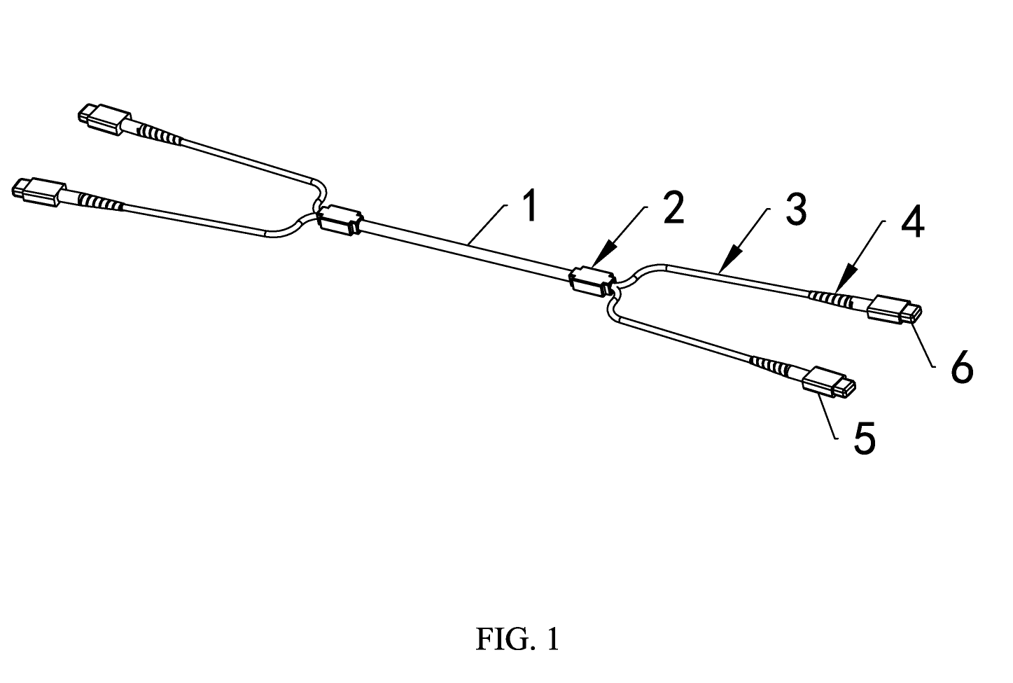

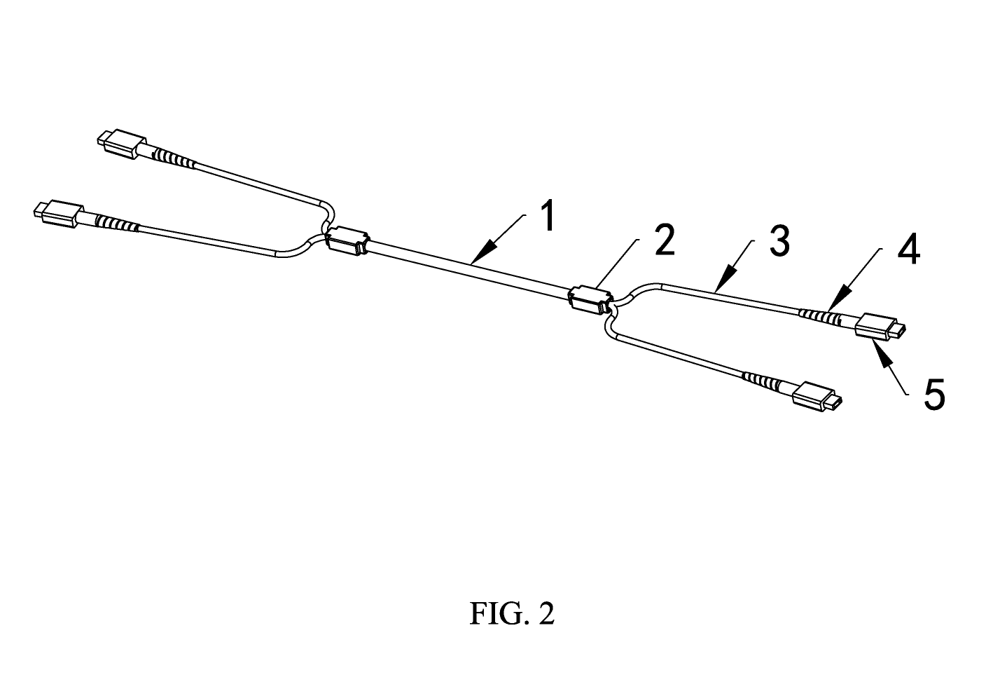

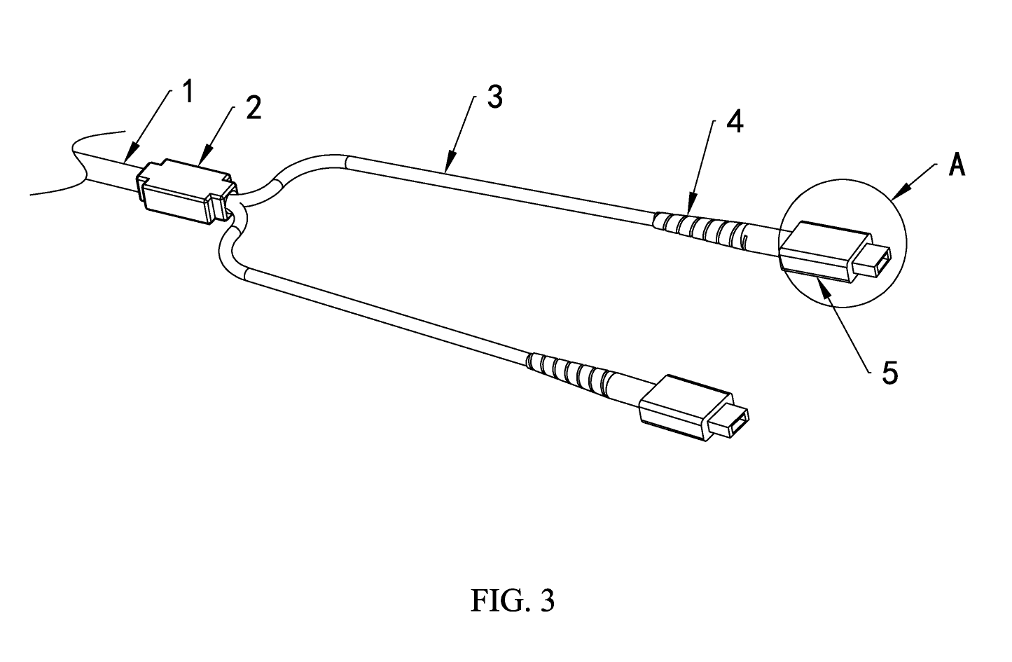

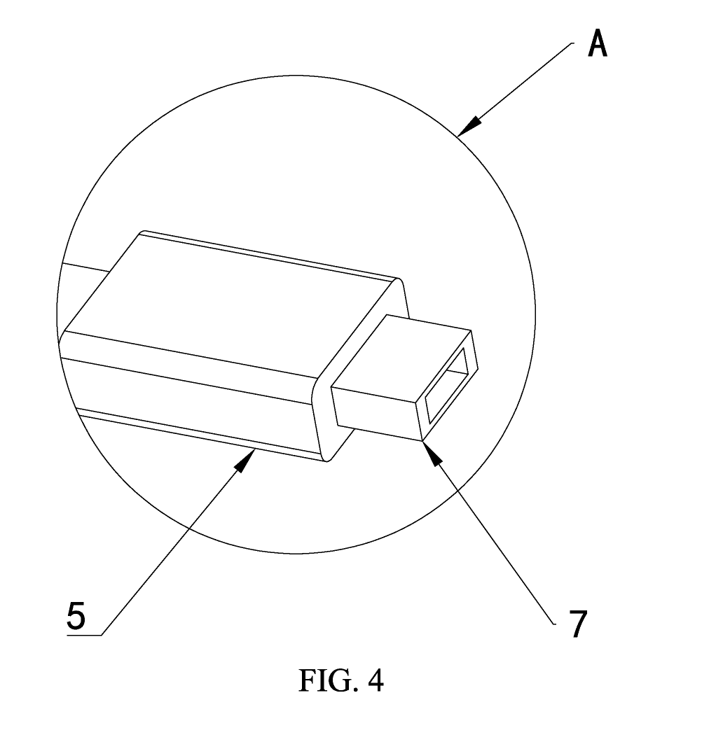

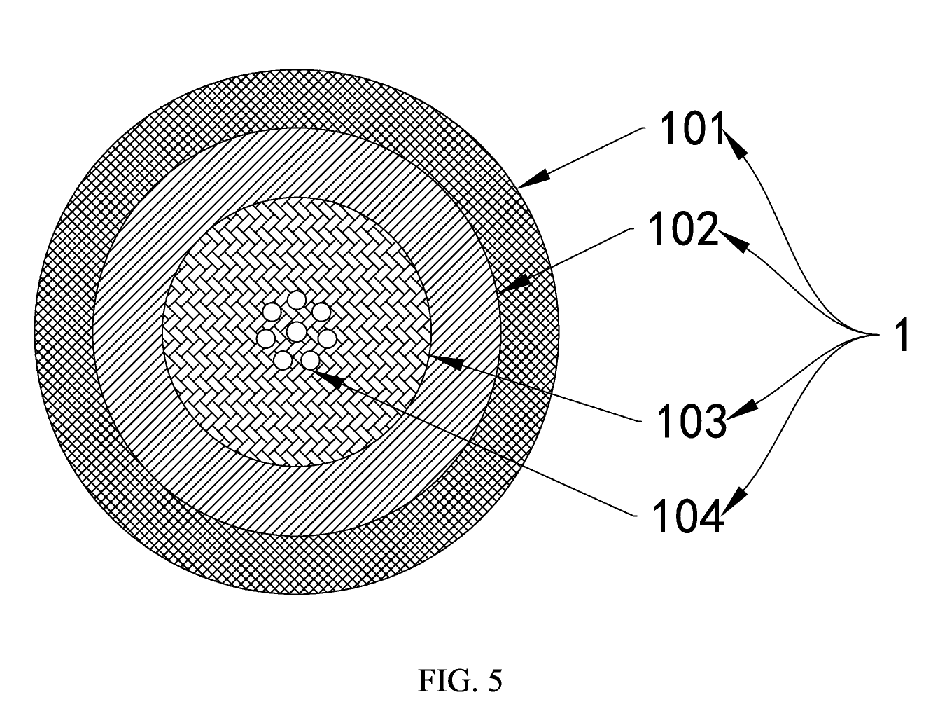

Referring to FIGS. 1-5, an ultra-bend-resistant flexible braided multi-core MPO pre-terminated assembly comprises a multi-core ultra-bend-resistant flexible braided optical cable 1. Both ends of the multi-core ultra-bend-resistant flexible braided optical cable 1 are provided with an external black heat-shrinkable tube 2 for a branch device. Mutually symmetrical multi-core ultra-bend-resistant flexible braided empty tubes 3 are provided on a side of the external black heat-shrinkable tube 2 away from the multi-core ultra-bend-resistant flexible braided optical cable 1. A connector rubber protective boot 4 is provided on a side of each multi-core ultra-bend-resistant flexible braided empty tube 3 away from the external black heat-shrinkable tube 2. A multi-core connector 5 is provided at an end of each connector rubber protective boot 4 away from the multi-core ultra-bend-resistant flexible braided empty tube 3. A tip 7 is provided at an end of each multi-core connector 5 away from the connector rubber protective boot 4, and a tip protective cap 6 is provided on an outer wall of the tip 7.

As the core transmission component of the entire system, the multi-core ultra-bend-resistant flexible braided optical cable 1 is provided at both ends thereof with external black heat-shrinkable tubes 2 for branch devices. The heat-shrinkable tubes not only serve to protect the branches, but also have a black appearance that helps reduce optical reflection interference of the optical cable in certain environments. At an end of each external black heat-shrinkable tube 2 for the branch device away from the multi-core ultra-bend-resistant flexible braided optical cable 1, multi-core ultra-bend-resistant flexible braided empty tubes 3 are symmetrically disposed. The empty tubes further enhance the flexibility and bending resistance of the branch portions of the optical cable, ensuring stable operation of the optical cable even under complex cabling environments, while providing a stable support for the connection of subsequent components.On a side of each multi-core ultra-bend-resistant flexible braided empty tube 3 away from the external black heat-shrinkable tube 2 for the branch device, a connector rubber protective boot 4 is installed. The protective boot, by virtue of its good flexibility and cushioning performance, can effectively protect the internal connection components from external physical impact and friction damage, thereby extending the service life of the connector.At an end of the connector rubber protective boot 4 away from the multi-core ultra-bend-resistant flexible braided empty tube 3, a multi-core connector 5 is connected. As a key interface component of the optical cable system, the multi-core connector 5 features high-precision, high-density connection characteristics, enabling fast and stable connection of multi-core optical fibers to meet the demands of high-speed data transmission.At an end of the multi-core connector 5 away from the connector rubber protective boot 4, a tip 7 is provided. A tip protective cap 6 is additionally provided on an outer wall of the tip 7, providing comprehensive protection for the tip and preventing damage such as collision and scratching during transportation, installation, and use, thereby ensuring the reliability and stability of the entire optical cable system.

The number of the external black heat-shrinkable tubes 2 for the branch device is two, the number of the multi-core ultra-bend-resistant flexible braided empty tubes 3 is four, the number of the connector rubber protective boots 4 is four, the number of the multi-core connectors 5 is four, the number of the tip protective caps 6 is four, and the number of the tips 7 is four.

As a key component for branch protection at both ends of the optical cable, the external black heat-shrinkable tubes 2 for the branch device are two in number and are respectively installed at the two ends of the multi-core ultra-bend-resistant flexible braided optical cable 1. The heat-shrinkable tubes can effectively seal and protect the branch portions of the optical cable, preventing intrusion of external environmental factors such as moisture and dust. Meanwhile, the black appearance helps reduce optical reflection interference, thereby improving the transmission performance of the optical cable.The multi-core ultra-bend-resistant flexible braided empty tubes 3 serve the important function of enhancing the flexibility and bending resistance of the branch portions of the optical cable, and are four in number. For each end of the optical cable, two multi-core ultra-bend-resistant flexible braided empty tubes 3 correspond to the branch structure and are symmetrically arranged, providing stable support for subsequent connection components and ensuring that the branch portions of the optical cable can bend flexibly without damaging the internal optical fibers even under complex cabling environments.The connector rubber protective boots 4, by virtue of their good flexibility and cushioning performance, provide reliable protection for the internal connection components, and are also four in number. Each connector rubber protective boot 4 is tightly fitted on a side of the multi-core ultra-bend-resistant flexible braided empty tube 3 away from the external black heat-shrinkable tube 2 for the branch device, effectively resisting external physical impact and friction, thereby extending the service life of the connector.The multi-core connectors 5 are core interface components of the optical cable system, featuring high-precision, high-density connection characteristics. There are four multi-core connectors 5, each installed at an end of the connector rubber protective boot 4 away from the multi-core ultra-bend-resistant flexible braided empty tube 3. The multi-core connectors 5 enable fast and stable connection of multi-core optical fibers to meet the requirements of high-speed data transmission, ensuring efficient and accurate signal transmission in the optical cable system.The tips 7 are the most distal components of the optical cable connection, and are four in number. A tip protective cap 6 is provided on an outer wall of each tip 7. The number of the tip protective caps 6 is also four. The tip protective caps 6 provide comprehensive protection for the tips, preventing damage such as collision and scratching during transportation, installation, and use, thereby ensuring the reliability and stability of the entire optical cable system.

The multi-core ultra-bend-resistant flexible braided optical cable 1 comprises a braided layer 101. An outer jacket 102 is provided between opposite inner walls of the braided layer 101. An aramid yarn layer 103 is provided between opposite inner walls of the outer jacket 102. A plurality of optical fibers 104 are provided inside the aramid yarn layer 103.

The outermost layer is the braided layer 101, which is made using a specialized braiding process and material. The braided structure not only provides excellent flexibility to the optical cable, allowing it to bend flexibly in complex environments without damage, but also possesses strong tensile and lateral compression resistance, effectively protecting the internal components from damage by external mechanical forces. Additionally, the braided layer 101 provides a certain shielding effect, reducing the impact of external electromagnetic interference on signal transmission of the optical cable.Between opposite inner walls of the braided layer 101, an outer jacket 102 is disposed. The outer jacket 102 is typically made of a high-performance plastic material, exhibiting good corrosion resistance, wear resistance, and insulating properties. It is tightly fitted inside the braided layer 101, further enhancing the mechanical strength of the optical cable, preventing intrusion of external substances such as moisture and dust into the interior of the optical cable, and providing a stable, dry working environment for the internal components.Between opposite inner walls of the outer jacket 102 is an aramid yarn layer 103. Aramid yarn is a synthetic fiber with high strength and high modulus, possessing excellent tensile properties and heat resistance. The aramid yarn layer 103 is uniformly distributed inside the outer jacket 102, forming a robust protective barrier within the optical cable. When the optical cable is subjected to tensile force, the aramid yarn layer 103 can bear most of the tensile load, effectively protecting the internal optical fibers 104 from being broken, thereby greatly improving the tensile strength and service life of the optical cable.Inside the aramid yarn layer 103, a plurality of optical fibers 104 are provided. The optical fibers 104 are the core transmission components of the optical cable, made using advanced optical materials and manufacturing processes, and feature low loss and high bandwidth. The plurality of optical fibers 104 are arranged in parallel, enabling simultaneous transmission of large amounts of data information to meet the demands of modern communication for high-speed, high-capacity data transmission. The optical fibers 104 are isolated and protected from each other by a special buffer material, avoiding mutual interference and collision, and ensuring the stability and reliability of signal transmission.

The braided layer 101 is made of PET material, which serves as an MPO braided cable material.

PET material, i.e., polyethylene terephthalate, is a common and high-performance polymer. When used in the braided layer 101 of the MPO braided cable, it exhibits numerous outstanding characteristics. In terms of physical properties, PET material has high strength and toughness, enabling the braided layer 101 to withstand external forces such as tension, bending, and compression to a certain extent without being prone to fracture or deformation. During actual use of the optical cable, whether under repeated bending during installation and wiring or under external impact such as accidental collision, the PET braided layer 101 provides reliable protection for the internal components such as optical fibers, ensuring the structural integrity of the optical cable and the stability of signal transmission.In terms of chemical properties, PET material has good chemical resistance and can withstand erosion by various common chemical substances such as acids, alkalis, and salts. In some special application environments, such as chemical plants or marine environments, the optical cable may come into contact with various chemical substances. The PET braided layer 101 can effectively prevent these chemical substances from causing damage to the interior of the optical cable, thereby extending the service life of the optical cable.PET material also exhibits excellent weatherability. It can withstand a wide range of temperature variations, being resistant to softening and deformation in high-temperature environments and not becoming brittle or easily cracked in low-temperature environments. Whether in hot desert regions or cold polar environments, the PET braided layer 101 can maintain stable performance, ensuring normal operation of the optical cable under various harsh climatic conditions.Additionally, PET material is easy to process and mold. It can be formed into the braided layer 101 that meets requirements through a specific braiding process. This braided structure not only increases the flexibility of the optical cable but also provides a certain shielding performance, reducing the impact of external electromagnetic interference on signal transmission of the optical cable, further improving the transmission quality of the optical cable.

The outer jacket 102 is made of nylon material.

Nylon material, as a widely used engineering plastic, possesses excellent mechanical properties, with high strength and hardness. This enables the outer jacket 102 to effectively withstand external mechanical damage such as compression and impact. During laying and installation of the optical cable, it may encounter various complex environments and handling conditions. The nylon outer jacket 102 can withstand a certain degree of external impact, preventing damage to key components such as the internal optical fibers and braided layer, thereby ensuring the structural integrity of the optical cable.Additionally, nylon material has good flexibility. Although it has high strength, it does not become stiff and brittle. Instead, it can be bent and twisted within a certain range, allowing the optical cable to adapt flexibly to various bending paths and space constraints during wiring. Whether passing through narrow conduits or being connected inside complex equipment, the nylon outer jacket 102 ensures smooth installation of the optical cable without issues such as breakage or performance degradation caused by excessive bending.During long-term use, the optical cable inevitably comes into friction with other objects in the surrounding environment, such as contact with the ground, walls, or other cables. The nylon outer jacket 102 can withstand such frequent friction, being resistant to wear and scratching, thereby effectively protecting the internal optical fibers from external environmental influences and extending the service life of the optical cable.Nylon material also has good chemical resistance. In some special application environments, the optical cable may come into contact with various chemical substances such as acids, alkalis, and oils. The nylon outer jacket 102 can resist erosion by these chemical substances, preventing them from penetrating into the interior of the optical cable and causing damage to the optical fibers and other components, ensuring normal operation of the optical cable under various harsh chemical environments.Furthermore, nylon material has a certain degree of flame retardancy. In the event of an emergency such as a fire, it can slow the spread of flames, gaining valuable time for personnel evacuation and equipment rescue, reducing the degree of damage to the optical cable system caused by fire, and improving the safety of optical cable use.

The aramid yarn layer 103 is made of PTFE material.

PTFE material has chemical stability and hardly reacts with any chemical substances. Whether strong acids, strong alkalis, strong oxidants, or various organic solvents, it is difficult to cause erosion to PTFE. In various harsh chemical environments that the optical cable may encounter, such as chemical production workshops or marine environments, the PTFE aramid yarn layer 103 can remain stable, forming a reliable chemical protective barrier for the core components such as the internal optical fibers, effectively preventing chemical substances from penetrating and causing performance degradation or damage to the optical fibers, thereby greatly extending the service life of the optical cable.In terms of physical properties, PTFE material has an extremely low coefficient of friction, resulting in minimal friction between the yarns themselves and between the yarns and other components when the optical cable is subjected to external forces such as bending, twisting, or stretching. This low-friction characteristic not only reduces energy loss and heat generation during movement of the optical cable but also avoids yarn wear and breakage caused by friction, ensuring the stability and reliability of the optical cable under frequent operation and complex motion environments.PTFE material also exhibits excellent high-temperature and low-temperature resistance, with an extremely wide operating temperature range. In high-temperature environments, even at temperatures as high as several hundred degrees Celsius, the PTFE aramid yarn layer 103 does not undergo softening, deformation, or decomposition, and maintains its original mechanical properties and structural integrity, ensuring normal operation of the optical cable in high-temperature locations such as metallurgy and power industries. In low-temperature environments, it does not become brittle and easily cracked like some common materials, and can withstand extremely low temperatures without affecting the flexibility and tensile performance of the optical cable, allowing the optical cable to operate stably in cold outdoor or polar regions.PTFE material has good electrical insulation properties, and moisture is difficult to adhere to or penetrate its surface. This further enhances the moisture protection capability of the aramid yarn layer 103. In humid environments, the PTFE aramid yarn layer 103 can effectively prevent moisture from entering the interior of the optical cable, avoiding signal attenuation and performance degradation of the optical fibers caused by moisture, ensuring long-term reliable operation of the optical cable in humid environments.

The multi-core connector includes an MPO connector end, an SC connector end, an FC connector end, an LC connector end, and an ST connector end.

The foregoing has shown and described the basic principles, main features, and advantages of the present invention. Those skilled in the art should understand that the present invention is not limited to the above-described embodiments. The above embodiments and descriptions are merely illustrative of the principles of the present invention. Various changes and modifications may be made to the present invention without departing from the spirit and scope thereof. Such changes and modifications all fall within the scope of the present invention as claimed.

What is claimed is:

1. An ultra-bend-resistant flexible braided multi-core MPO pre-terminated assembly, comprising a multi-core ultra-bend-resistant flexible braided optical cable, characterized in that:
both ends of the multi-core ultra-bend-resistant flexible braided optical cable are provided with an external black heat-shrinkable tube for a branch device;
a side of the external black heat-shrinkable tube for the branch device away from the multi-core ultra-bend-resistant flexible braided optical cable is provided with mutually symmetrical multi-core ultra-bend-resistant flexible braided empty tubes;
a side of each of the multi-core ultra-bend-resistant flexible braided empty tubes away from the external black heat-shrinkable tube for the branch device is provided with a connector rubber protective boot;
an end of each of the connector rubber protective boots away from the multi-core ultra-bend-resistant flexible braided empty tube is provided with a multi-core connector;
an end of each of the multi-core connectors away from the connector rubber protective boot is provided with a tip; and
an outer wall of the tip is provided with a tip protective cap.

2. The ultra-bend-resistant flexible braided multi-core
MPO pre-terminated assembly according to claim 1, characterized in that the number of the external black heat-shrinkable tubes for the branch device is two, the number of the multi-core ultra-bend-resistant flexible braided empty tubes is four, the number of the connector rubber protective boots is four, the number of the multi-core connectors is four, the number of the tip protective caps is four, and the number of the tips is four.

3. The ultra-bend-resistant flexible braided multi-core MPO pre-terminated assembly according to claim 2, characterized in that the multi-core ultra-bend-resistant flexible braided optical cable comprises a braided layer, an outer jacket is provided between opposite inner walls of the braided layer, an aramid yarn layer is provided between opposite inner walls of the outer jacket, and a plurality of optical fibers are provided inside the aramid yarn layer.

4. The ultra-bend-resistant flexible braided multi-core MPO pre-terminated assembly according to claim 3, characterized in that the braided layer is made of PET material, which serves as an MPO braided cable material.

5. The assembly according to claim 4, characterized in that the outer jacket is made of nylon material.

6. The assembly according to claim 5, characterized in that the aramid yarn layer is made of PTFE material.
